(19) United States
(12) Patent Application Publication
(10) Pub. No.: US 2022/0347555 A1
(43) Pub. Date: Nov. 3, 2022

(54) TEACHING AND LEARING METHOD USING A GAME OF RANDOM SELECTION

(71) Applicant: Theda Eugenia, Rialto, CA (US)

(72) Inventor: Theda Eugenia, Rialto, CA (US)

(21) Appl. No.: 17/865,129

(22) Filed: Jul. 14, 2022

Related U.S. Application Data
(63) Continuation-in-part of application No. 16/786,776, filed on Feb. 10, 2020.

(51) Int. Cl. A63F 9/30; A63F 9/34; G09B 1/16

(52) U.S. Cl. CPC A63F 9/305; A63F 9/34; G09B 1/16

(57) ABSTRACT

A method of teaching and learning using a game of random selection wherein each student in a group of students takes a turn to catch an object in a container with a fishing pole. The object caught in the container is pulled out of the container. The student identifies the indicia on the object to the group of students, wherein indicia include letters, words, numbers, colors, and shapes. If the student makes a correct identification, the student retains the object. A teacher provides a reward to the student based on the number of objects identified correctly. The teacher can identify students with insufficient success in identifying indicia correctly and can have these students practice the game of random selection to improve retention of the correct identifications of the indicia. Students can move around and interact with each other while learning and having fun, while retention of learned subject matter is being reinforced.

### CROSS REFERENCE TO RELATED APPLICATION

This patent application is a continuation in part of, and claims the benefit of, U.S. patent application Ser. No. 16/786,776, filed Feb. 10, 2020, currently pending, and is hereby incorporated herein by reference in its entirety.

### FIELD OF THE INVENTION

This invention relates to educational toys and games and, more particularly, to a method of teaching children and enhancing learning through playing a teaching and learning game of random selection in a social and learning environment.

### BACKGROUND OF THE INVENTION

Learning in school by a child is usually by reading, answering questions, and writing answers. In the process of learning this way a child can lose interest in the subject matter and become unsettled or distracted. The child usually enjoys playing more than reading. Learning through motion, such as during playing, may be easier for a child than just reading and may improve retention of what is learned. US Patent Application 2005/0059317 discloses an educational fishing toy wherein a child catches a toy fish from among a plurality of toy fishes. The toy fishes may have numbers, letters, and colors attached thereto to teach addition or subtraction. There is no disclosure of human social interaction for reinforcing the learning process. Thus, a child may use the toy for entertainment only and eventually abandon the toy. What is needed is a method of gaming in a human social and learning environment to sustain a child's interest in the learning process and to reinforce the child's learning and retention. The game of this invention can be used at home where the child practices skills previously learned as well as to attempt new skills.

### SUMMARY OF THE INVENTION

The present invention is a method of teaching and learning using a game of random selection for young children, wherein each student in a group of students takes a turn to catch an object in a container with a fishing pole. The object caught in the container is pulled out of the container with the fishing pole. Each student identifies indicia on the object to the group of students, wherein, if a student makes a correct identification, the student retains the object. A teacher provides a reward to each student based on the number of objects identified correctly. Each student makes a written record of the number of objects caught and the number of objects wherein the indicia is identified correctly. Each student makes a written record of the indicia used in the game, wherein indicia include letters, words, numbers, colors, and shapes. A teacher may provide a suggestion to help the student identify the indicia. The teacher identifies those students with insufficient success in identifying indicia correctly and has these students practice the game of random selection to improve retention of the correct identifications of the indicia.

The teacher can create simple exercises to reinforce retention of the lessons learned from the indicia. For example, the teacher may have the student use the words on the indicia in a sentence. The teacher may have the student build subtraction or addition problems with another student in the group of students, when the indicia on the objects are numbers. The group of students can make a story book featuring indicia shown on the objects.

An advantage of the method of this invention is the ability for students to move around and interact with each other while learning.

Another advantage is a fun game of random selection that reinforces retention of learned subject matter.

Another advantage is a reward system that incentivizes the students.

Another advantage is the ability of a teacher to identify subject matter with which a student is having difficulty.

Another advantage is that students get to demonstrate their knowledge to peers.

Another advantage is that students learn from one another.

Another advantage is that children learn team work.

Another advantage is that children learn social responsibility.

### BRIEF DESCRIPTION OF THE DRAWINGS

FIG. 1 is an illustration of a fishing rod type of device for use in a teaching and learning game of random selection.

FIG. 2 is a side view of an object, in the form of a fish used in the game of random selection.

FIG. 3 is an illustration of the fishing rod type device as it is used in the game of random selection.

### DESCRIPTION OF THE INVENTION

While the following description details the preferred embodiments of the present invention, it is to be understood that the invention is not limited in its application to the details of arrangement of the parts or steps of the methods illustrated in the accompanying figures, since the invention is capable of other embodiments and of being practiced in various ways.

A fishing rod type of device is used in the method of this invention to catch an object present among several other objects, for example 20-30 other objects. The fishing rod type device and the object provide a game of random selection. The objects are, preferably, flat and have one or more magnets attached to a surface of the object. The objects may be spread out on the bottom of a container placed on a floor.

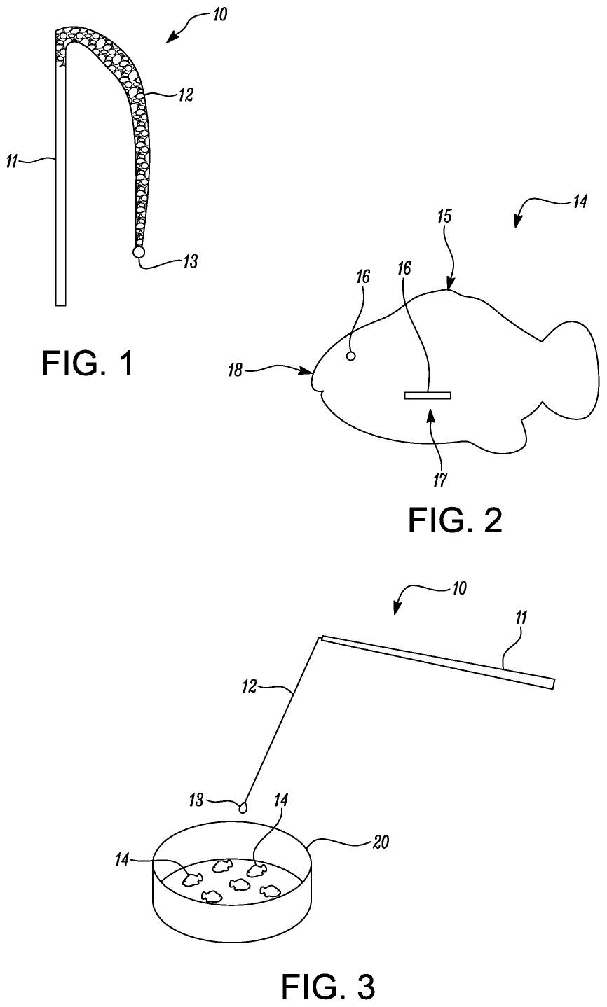

FIG. 1 shows an example of a fishing rod type device 10 having a pole 11 and a cord or fishing line 12. The cord 12 is attached to one end of the pole 11. The opposite end of the cord 12 has a magnet 13. FIG. 2 shows an object 14 designed to be “caught” with the fishing rod type device 10. Object 14 may be in the shape of, for example, a fish or any other desired shape. An area 15 on the object 14 may be used for adding indicia such as numbers, letters, words, colors, shapes, pictures, and the like. One or more magnets 16 may be placed on the object 14, for example in the middle 17 or on an end 18 of the object 14. When playing the game of random selection, the magnet 13 on the cord 12 is lowered into a container 20 (see FIG. 3) having the objects 14. The magnet 13 attaches to a magnet 16 on an object 14 as the magnet 13 is moved around in the container 20 using the pole 11. Once the magnet 13 on the cord 12 attaches to a magnet 16 on an object 14, the object 14 can be pulled out of the container 20 using the pole 11. FIG. 3 shows the pole 11, cord 12, and magnet 13 positioned over the objects 14 in the container 20, ready to play the game of random selection.

The game of random selection is used to implement the teaching and learning method of the present invention. The game of random selection is played, preferably, with a group of students, in the presence of a teacher, and according to instructions in an assignment. The fish object can be imprinted with various words, shapes, numbers, letters, and concepts in an array of colors. Each fish would also have a magnet. A group of students playing the game take turns using the pole to ‘catch’ a fish (object). When a student catches and pulls a fish out of the container, the student must correctly identify the word, letter, shape, color, number, or any other indicia to keep the fish and to score points. Students can also form sentences using words shown on a plurality of caught fish. The game may include a storybook featuring the indicia and words shown on a plurality of fish. Preferably, the book is made by the students. A guide may be provided that goes with the activities and is assigned or used as selected.

There are numerous ways to use and play the fish game. A teacher may assign lessons to a group of students who need practice learning specific subject matter. For example, a group of kindergarten students may practice the ABC's by each student hooking a fish and saying the name of the letter on the fish to the group of students. The teacher may say the letter sound as needed. The student keeps the fish if he or she identifies the letter correctly. A tally of the number of fish is kept for each student, and rewards are earned for the number of fish a student has at the end of each fish game. A teacher may use the fish game on a one-to-one basis with a student or a group of students.

The fish game is useful for teaching mathematics and can help students having difficulty with subtraction, for example. A student can catch and retrieve several numbered fish and build a subtraction problem with a fellow student. The student can identify a “big” number fish and a “small” number fish and be given the instruction to subtract the small number from the big number. Movement and handling of the objects allow the student to better understand the concept of subtraction: taking a smaller number from a larger number. Practicing with the fish game can be repeated several times and a record of each practice may be recorded in the student's math journal.

The foregoing description illustrates and describes the disclosure. Additionally, the disclosure shows and describes only the preferred embodiments but, it is to be understood that the preferred embodiments are capable of being formed in various other combinations, modifications, and environments and are capable of changes or modifications within the scope of the invention concepts as expressed herein, commensurate with the above teachings and/or the skill or knowledge of the relevant art. The embodiments described herein above are further intended to explain the best modes known by applicant and to enable others skilled in the art to utilize the disclosure in such, or other, embodiments and with the various modifications required by the particular applications or uses thereof. Accordingly, the description is not intended to limit the invention to the form disclosed herein. Also, it is intended that the appended claims be construed to include alternative embodiments. It will be further understood that various changes in the details, materials, and arrangements of the parts which have been described and illustrated above in order to explain the nature of this invention may be made by those skilled in the art without departing from the principle and scope of the invention as recited in the following claims.

I claim:

1. A method of teaching and learning using a game of random selection, comprising:
1) providing a game of random selection having a fishing pole, a container, and objects therein;
2) taking a turn by each student in a group of students to catch an object in a container with a fishing pole;
3) pulling the object caught in the container out of the container with the fishing pole;
4) identifying by the student indicia on the object to the group of students, wherein, if the student makes a correct identification, the student retains the object; and
5) providing a reward by a teacher to the student based on the number of objects identified correctly.

2. The method of claim 1, further comprising making a written record by the student of the number of objects caught and the number of objects wherein the indicia is identified correctly.

3. The method of claim 1, further comprising the student making a written record of the indicia used in the game, wherein indicia include letters, words, numbers, colors, and shapes.

4. The method of claim 1, further comprising providing by the teacher a suggestion to help the student identify the indicia.

5. The method of claim 1, further comprising identifying students with insufficient success in identifying indicia correctly and having these students practice the game of random selection to improve retention of the correct identifications of the indicia.

6. The message of claim 1, further comprising using by the student words on the indicia in a sentence.

7. The method of claim 1, further comprising building subtraction or addition problems by the student with another student in the group of students, when the indicia on the objects are numbers.

8. A method of teaching and learning using a game of random selection, comprising:
1) providing a game of random selection having a fishing pole, a container, and objects therein;
2) taking a turn by each student in a group of students to catch an object in a container with a fishing pole;
3) pulling the object caught in the container out of the container with the fishing pole;
4) identifying by the student indicia on the object to the group of students, wherein, if the student makes a correct identification, the student retains the object;
5) providing a reward by a teacher to the student based on the number of objects identified correctly;
6) making a written record by the student of the number of objects caught and the number of objects wherein the indicia is identified correctly;
7) making a written record of the indicia used in the game by the student, wherein indicia include letters, words, numbers, colors, and shapes; and
8) providing by the teacher a suggestion to help the student identify the indicia.

9. The method of claim 8, further comprising identifying students with insufficient success in identifying indicia correctly and having these students practice the game of random selection to improve retention of the correct identifications of the indicia.

10. The method of claim 8, further comprising using by the student words on the indicia in a sentence.

11. The method of claim 8, wherein the indicia on the objects are numbers, further comprising building a subtraction or addition problem by the student with another student in the group of students.

12. A method of teaching and learning using a game of random selection, comprising:
1) providing a game of random selection having a fishing pole, a container, and objects therein;
2) taking a turn by each student in a group of students to catch an object in a container with a fishing pole;
3) pulling the object caught in the container out of the container with the fishing pole;
4) identifying by the student indicia on the object to the group of students, wherein, if the student makes a correct identification, the student retains the object;
5) providing a reward by a teacher to the student based on the number of objects identified correctly;
6) making a written record by the student of the number of objects caught and the number of objects wherein the indicia is identified correctly;
7) making a written record of the indicia used in the game by the student, wherein indicia include letters, words, numbers, colors, and shapes;
8) providing by the teacher a suggestion to help the student identify the indicia;
9) identifying by the teacher students with insufficient success in identifying indicia correctly and having these students practice the game of random selection to improve retention of the correct identifications of the indicia; and
10) using by the student words on the indicia in a sentence.

13. The method of claim 12, further comprising building subtraction or addition problems by the student with another student in the group of students, when the indicia on the objects are numbers.

14. The method of claim 1, further comprising making a story book by the group of students, the story book featuring indicia shown on the objects.

15. The method of claim 8, further comprising making a story book by the group of students, the story book featuring indicia shown on the objects.

16. The method of claim 12, further comprising making a story book by the group of students, the story book featuring indicia shown on the objects.
